(19) United States
(12) Patent Application Publication
(10) Pub. No.: US 2022/0408672 A1
(43) Pub. Date: Dec. 29, 2022

(54) GROW POT APPARATUS AND SYSTEM

(71) Applicant: MJNN LLC, South San Francisco, CA (US)

(72) Inventors: Damon SMITH, Laramie, WY (US); Matthew Arrington, Laramie, WY (US); Kevin GRAUBERGER, Laramie, WY (US); Aunders R. HALLSTEIN, Cheyenne, WY (US)

(21) Appl. No.: 17/765,246

(22) PCT Filed: Sep. 30, 2020
(86) PCT No.: PCT/US2020/053536

§ 371 Date: Mar. 30, 2022

Related U.S. Application Data
(60) Provisional application No. 62/908,571, filed on Sep. 30, 2019.

(51) Int. Cl. A01G 31/06

(52) U.S. Cl. CPC A01G 31/06

(57) ABSTRACT

The present disclosure relates to apparatus for growing plants. More specifically, apparatus described herein relate to an inverted controlled irrigation grow pot (100). In one embodiment, a plant pot includes a multi-walled tube which defines a plurality of volumes therein to facilitate inverted growth of a plant while accounting for the geotropic nature of root proliferation. Embodiments of the disclosure also provide for controlled irrigation of a plant grown in an inverted orientation. Further embodiments of the disclosure provide for plant propagation systems which include multiple plant pots. In certain embodiments, load cells (802, 1002, 1101, 1102, 1202) are incorporated in to the systems to enable detection and measurement of plant pot weights.

### BACKGROUND

### Field

Embodiments of the present disclosure generally relate to apparatus for plant propagation and growth. More specifically, embodiments of the present disclosure relate to a grow pot apparatus and system.

### Description of the Related Art

During the twentieth century, agriculture slowly began to evolve from a conservative industry to a fast-moving high-tech industry in order to keep up with world food shortages, climate change, and societal changes moving away from manually-implemented agriculture techniques increasingly toward computer implemented technologies. In the past, and in many cases still today, farmers only have one growing season to produce the crops which ultimately determines their revenue and food production for the entire year. However, recent advances have disrupted conventional farming and food production practices. As indoor agriculture becomes more viable and increasingly employs data processing technologies and other advanced techniques, the science of agriculture has become more agile and is adapting and learning as new data is collected and insights are generated.

Conventional agricultural practices rely upon the availability of arable land, but are subject to various environmental pressures, such as drought, pest, and disease pressures. Advancements in technology have led to the advent of controlled indoor agriculture. Improved efficiencies in space utilization, lighting, and a better understanding of hydroponics, aeroponics, crop cycles, and advancements in environmental control systems have allowed humans to create environments that are more conducive for agriculture to increase yields per square foot, nutrition, and other desirable produce characteristics, such as taste, color, etc.

One aspect of controlled indoor agriculture is the utilization of a vertical growth architecture where plants are grown adjacent to one another along a substantially common vertical axis. Plants grown in such a vertical architecture are “stacked” on top of one another. While vertical growing architectures reduce the amount of land area utilized for crop production, challenges exist with the implementation of vertical architectures for certain crop types. For example, growth, size, and fruiting characteristics of certain crop types may not be well suited for growing in vertical growth architectures. Conventional approaches to accommodate certain crops include trellising and the like, however, such trellising architectures are often not practical or scalable in a vertical growth architecture.

Accordingly, there is a need in the art for improved systems, apparatus, and methods to facilitate plant growth.

### SUMMARY

In one embodiment, a plant pot apparatus is provided. The apparatus includes a first wall having a first end and a second end, a second wall having a first end and a second end, the second wall disposed radially inward of the first wall, and a base member extending between the second end of the first wall and the second end of the second wall. The apparatus also includes a first outlet formed through the base member, a second outlet formed through the first wall, and a plug holder coupled to the first end of the second wall.

In another embodiment, a plant pot apparatus is provided. The apparatus includes a cylindrical first wall having a first radius and a first length and a cylindrical second wall having a second radius and a second length less than the first radius and first length, respectively. The apparatus also includes a base member extending between the cylindrical firs wall and the cylindrical second wall, a cap coupled to the cylindrical first wall opposite the base member, and a plug holder coupled to the cylindrical second wall between the cap and the base member.

In another embodiment, a planting system is provided. The planting system includes a first plant pot which includes a first wall having a mount extending radially outward of the first wall, a second wall, and a base member having an outlet disposed therein, the base member extending between the first wall and the second wall. The system also includes a second plant pot which includes a first wall having a mount extending radially outward of the first wall, a second wall, a base member extending between the first wall and the second wall, and a cap having an inlet formed therein, the cap coupled to the first wall. The system further includes a coupling element extending from the first wall mount of the first plant pot to the first wall mount of the second plant pot and a conduit extending from the outlet of the base member of the first plant pot to the inlet of the cap of the second plant pot.

In another embodiment, a plant propagation apparatus is provided. The apparatus includes a first grow pot, a second grow pot, a load cell disposed between the first grow pot and the second grow pot, a first connector disposed between the first grow pot and the load cell, and a second connector disposed between the second grow pot and the load cell.

In another embodiment, a plant propagation apparatus is provided. The apparatus includes a column, a plurality of brackets coupled to the column, a first grow pot coupled to a first bracket of the plurality of brackets, and a second grow pot coupled to a second bracket of the plurality of brackets. The second bracket is coupled to the column beneath the first bracket, a first connector is coupled to the first grow pot, a second connector is coupled to the second grow pot, and a load cell is disposed between and coupled to each of the first connector and the second connector.

In another embodiment, a plant propagation system is provided. The system includes a superstructure configured to support a plurality of grow pots suspended from the superstructure, a first connector coupled to the superstructure, a load cell coupled to the first connector, a second connector coupled to the load cell, and a first grow pot of the plurality of grow pots coupled to the second connector. One or more second grow pots of the plurality of grow pots are suspended from the first grow pot.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates a side view of an inverted controlled irrigation (ICI) grow pot according to an embodiment of the disclosure.

FIG. 2 illustrates a cross-sectional view of the grow pot of FIG. 1 according to an embodiment of the disclosure.

FIG. 3 illustrates a cross-sectional view of a cap for the grow pot of FIG. 1 according to an embodiment of the disclosure.

FIG. 4A illustrates a plan view of a plug holder for the grow pot of FIG. 1 according to an embodiment of the disclosure.

FIG. 4B illustrates a side view of the plug holder of FIG. 4A according to an embodiment of the disclosure.

FIG. 4C illustrates a cross-sectional view of a plug holder according to an embodiment of the disclosure.

FIG. 4D illustrates a cross-sectional view of a plug holder according to an embodiment of the disclosure.

FIG. 5 illustrates a cross-sectional view of the grow pot with a growth media contained therein according to an embodiment of the disclosure.

FIG. 6 illustrates a partial cross-sectional view of the grow pot with a plant disposed therein according to an embodiment of the disclosure.

FIG. 7 illustrates a side view of multiple grow pots arranged in a vertical architecture according to an embodiment of the disclosure.

FIG. 8 illustrates a side view of multiple grow pots arranged in a vertical architecture with a load cell between the grow pots according to an embodiment of the disclosure.

FIG. 9A illustrates a side view of multiple grow pots with a support member according to an embodiment of the disclosure.

FIG. 9B illustrates a schematic, sectional side view of the support member of FIG. 9A according to an embodiment of the disclosure.

FIG. 9C illustrates a schematic, sectional end view of the support member of FIG. 9A according to an embodiment of the present disclosure.

FIG. 10 illustrates a side view of multiple grow pots arranged in a vertical architecture with a load cell between the grow pots according to an embodiment of the disclosure.

FIG. 11A illustrates a side view of multiple grow pots arranged in a vertical architecture with a load cell between the grow pots according to an embodiment of the present disclosure.

FIG. 11B illustrates a side view of multiple grow pots arranged in a vertical architecture with a load cell between the grow pots according to an embodiment of the present disclosure.

FIG. 12A illustrates a grow pot system incorporating load cells according to an embodiment of the present disclosure.

FIG. 12B illustrates a grow pot system incorporating load cells according to an embodiment of the present disclosure.

FIG. 12C illustrates a grow pot system incorporating load cells according to an embodiment of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure relates to apparatus for growing plants. More specifically, apparatus described herein relate to an inverted controlled irrigation grow pot. In one aspect, a plant pot includes a multi-walled tube which defines a plurality of volumes therein to facilitate inverted growth of a plant while enabling geotropic root proliferation. The plurality of volumes include at least two volumes which are disposed vertically in a stacked orientation. Other volumes, which may include one or more of the vertically stacked volumes, are oriented such that at least one volume surrounds a different volume. For example, a first volume is stacked above a second volume and the second volume surround a third volume which is disposed below the first volume. Aspects of the disclosure also provide for controlled irrigation of a plant grown in an inverted orientation.

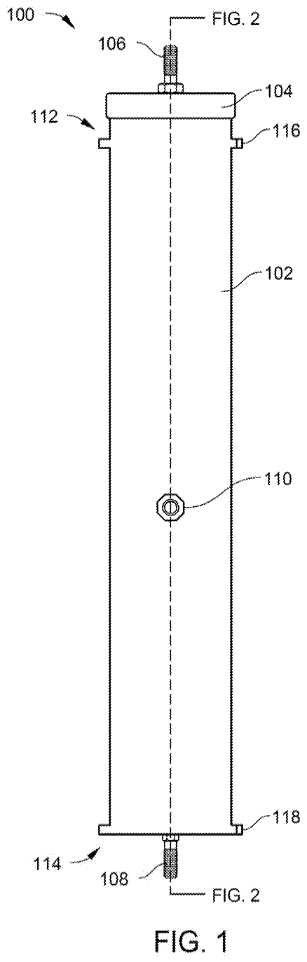

FIG. 1 illustrates a side view of an inverted controlled irrigation (ICI) grow pot 100 according to an embodiment of the disclosure. The grow pot 100 includes first wall 102 which extends from a first end 112 to a base member 114. In one example, the first wall 102 and the base member 114 are formed integrally with one another as a single piece. In another example, the base member 114 is removably coupled to the first wall 102. The first wall 102 and base member 114 are formed from a polymeric material, for example, a plastic material such as polyethylene (low-density, medium-density, high-density), polyethylene terephthalate, polyvinyl chloride, polypropylene, polytetrafluoroethylene, acrylonitrile butadiene styrene, or other suitable material. The material utilized may also include or incorporate one or more of durability enhancing material, such as a plasticizer material or ultraviolet light protective material. The durability enhancing material may be incorporated into the plastic material or may be coated on the plastic material depending upon the desired implementation. Other coatings which may be applied to the plastic material include non-stick coating, hydrophobic coatings, and anti-microbial coatings, among others.

It is contemplated that various other components of the grow pot 100 described herein may also be fabricated from the same or similar materials depending upon desired implementations. In one embodiment, each of the various components of the grow pot 100 described herein are fabricated by injection molding. However, it is contemplated that components of the grow pot 100 may be fabricated by other manufacturing processes, such as polymer casting, rotational molding, vacuum forming, extrusion, blow molding, subtractive manufacturing, or additive manufacturing (3D printing).

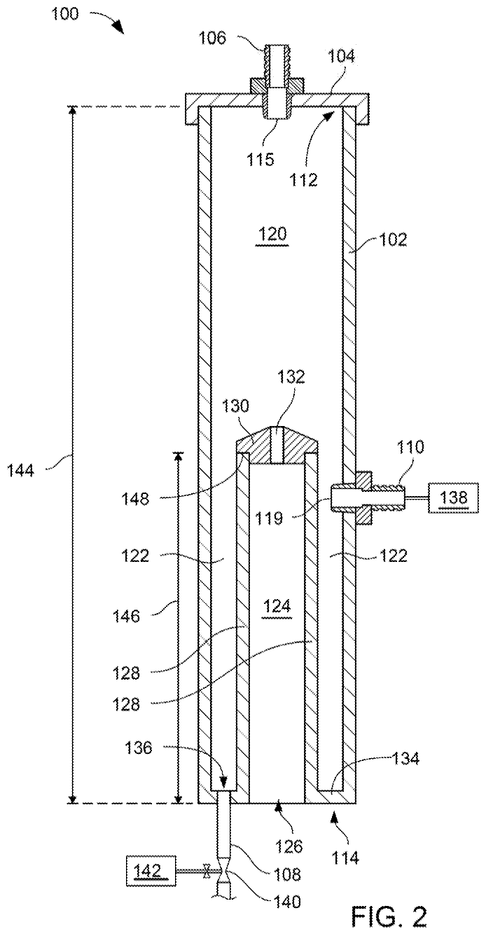

In one embodiment, the first wall 102 has a substantially tubular shape. For example, the first wall 102 is annular and includes an inner diameter and an outer diameter. It is contemplated that the first wall 102 may be implemented utilizing other shapes, such as a rectangular tube, polygonal tube, ovular tube, or other suitable shape. The base member 114 has a substantially annular shape as shown and described in greater detail with respect to FIG. 2 and the corresponding description.

First coupling elements 116 are coupled to the first wall 102 adjacent to and spaced from the first end 112 and extend radially outward from the first wall 102. In one embodiment, a plurality of first coupling elements 116, such as two coupling elements 116, are coupled to the first wall 102 opposing one another with 180° of separation. In another embodiment, a plurality of first coupling elements 116, such as three coupling elements 116, are coupled to the first wall 102 and are spaced from one another by approximately 120°. Second coupling elements 118 are coupled to the base member 114 and extend radially outward from the base member 114. In one embodiment, a plurality of second coupling elements 118, such as two coupling elements 118, are coupled to the base member 114 opposing one another with 180° of separation. In another embodiment, a plurality of second coupling elements 118, such as three coupling elements 118, are coupled to the base member 114 and are spaced from one another by approximately 120°.

Each of the first coupling element 116 and the second coupling element 118 are formed integrally with the first wall 102 and the base member 114, respectively. Alternatively, the first coupling element 116 and the second coupling element 118 may be separate components from the first wall 102 and are coupled to or otherwise fastened to the first wall 102. In the illustrated embodiment, the first coupling elements 116 are substantially vertically aligned with corresponding second coupling elements 118. Alternatively, the first coupling elements 116 and the second coupling elements 118 may be offset from one another with respect to a vertical plane. The first coupling element 116 and the second coupling element 118 may be a post-like or columnar extension from the first wall 102 and base member 114, respectively. The coupling elements 116, 118 may include a groove, notch, or depression, flared end, or other structural element which is configured to retain or otherwise couple to a wire, rope, threaded rod, or other similar connecting member when a plurality of the ICI grow pots 100 are disposed in a vertically aligned orientation.

A cap 104 is removably coupled to the first wall 102 at the first end 112. In one example, the cap 104 is threadably coupled to the first end 112 of the first wall 102. In this example, the first wall 102 includes threads which are sized to engage threads disposed on an interior of the cap 104 when the cap 104 is coupled to the first end 112 of the first wall 102. Each of the first coupling elements 116 and the second coupling elements 118 extend radially outward from the first wall 102 and the base member 114, respectively, beyond an outer diameter of the cap 104. The cap 104 is fabricated from the same or similar materials and by a similar fabrication process as the first wall 102.

A first hose adapter 106 is coupled to and extends through the cap 104. In the illustrated embodiment, the first hose adapter 106 is disposed in a center region of the cap 104. Alternatively, the first hose adapter 106 may be disposed through a region of the cap 104 which is off-center. The first hose adapter 106 is configured to connect to a fluid conduit and receive fluid therethrough such that fluid traverses through the first hose adapter 106, and thus the cap 104, into a volume at least partially defined by the first wall 102. The first hose adapter 106 may be fabricated from the same or similar materials and by a similar fabrication process as the cap 104. Alternatively, the first hose adapter 106 may be fabricated from any suitable material and may have any shape suitable for coupling a tube or connector to the cap 104. A third hose adapter 108, which may be similar to the first hose adapter 106, is coupled to and extends through the base member 114. The third hose adapter 108 is adapted to enable fluid to escape from a volume at least partially defined by the first wall 102 and the base member 114. A second hose adapter 110, which is similar to the first hose adapter 106 and the third hose adapter 108, is coupled to the first wall 102 between the first end 112 and the base member 114. Similar to the third hose adapter 108, the second hose adapter 110 is adapted to enable fluid to escape from the volume at least partially defined by the first wall 102.

FIG. 2 illustrates a cross-sectional view of the grow pot 100 of FIG. 1. As illustrated, the cap 104 is coupled to the first end 112 of the first wall 102 opposite the base member 114. The base member 114 extends radially inward from a second end 134 of the first wall 102. In the embodiment shown, the base member 114 extends from the first wall 102 in a substantially perpendicular direction. Alternatively, the base member 114 may have a conical or frustoconical shape. A second wall 128 extends from the base member 114 in a substantially perpendicular direction toward the first end 112 of the first wall 102. The second wall 128 is disposed radially inward of the first wall 102. In the illustrated embodiment, the first wall 102 surrounds the second wall 128 such that the first wall 102 is concentric with the second wall 128.

Similar to the first wall 102, the second wall 128 has a substantially tubular shape. The tubular shape may be annular, rectangular, ovular, polygonal or other suitable shape. In the embodiment shown, the tubular morphology of the first wall 102 and the tubular morphology of the second wall 128 are the same. In other embodiments, the tubular morphology of the first wall 102 and the second wall 128 can be different. In the embodiment shown, the first wall 102, the base member 114, and the second wall 128 are formed integrally with one another. In this embodiment, the second wall 128 is fabricated from the same materials and by the same fabrication processes as the first wall 102 and the base member 114. However, it is contemplated that each of the first wall 102, base member 114, and second wall 128 may be separate components coupled together.

A major axis of first wall 102 has a length 144 of between about 10 inches and about 30 inches, such as between about 16 inches and about 14 inches, for example, about 18 inches. A major axis of the second wall 128 has a length 146 of between about 3 inches and about 15 inches, such as between about 6 inches and about 12 inches, for example, about 9 inches. In one embodiment, a ratio of the length 144 to the length 146 is between about 1.5:1 and about 3:1, such as about 2:1. A diameter of the first wall 102 is between about 1 inch and about 12 inches, such as between about 2 inches and about 6 inches, for example about 3 inches. A diameter of the second wall 128 is between about 0.5 inches and about 6 inches, such as between about 1 inch and about 3 inches, for example, about 1.5 inches. In one embodiment, a ratio of the diameter of the first wall 102 to the diameter of the second wall 128 is between about 1.5:1 and about 3:1, such as about 2:1.

A plug holder 130 having a recess 132 formed therein is disposed on a first end 148 of the second wall 128. The plug holder 130 is removably coupled to the second wall 128 to enable the plug holder 130 to be removed from the grow pot 100. The recess 132 of the plug holder 130 is adapted to receive a root ball or root plug of a plant therein and position the plant within the grow pot 100 in an inverted orientation with respect to gravity.

The grow pot 100 includes a plurality of volumes 120, 122, 124 defined therein. A first volume 120 is defined by the first wall 102, the cap 104, and the plug holder 130. For example, the first volume 120 extends from the cap 104 to approximately the first end 148 of the second wall 128 where the plug holder 130 is disposed. The first volume 120 is adapted to function as an aerobic root growth region and may be filled with one or more growth media. A second volume 122 is defined by the first wall 102, the base member 114 and the second wall 128. For example, the second volume 122 extends from the second end 134 at the base member 114 the first end 148 of the second wall 128 and has an annular morphology. The second volume 122 is adapted to function as an aquatic and/or geotropic root growth region and may be filled with a fluid, for example, water or a nutrient containing liquid, at certain times during growth of the plant. A third volume 124 is defined, at least in part, by the second wall 128, the base member 114, and the plug holder 130. For example, the third volume 124 extends from the plug holder 130 to the second end 134 of the second wall 128 at the base member 114. The third volume 124 is adapted to function as a stem growth region to enable stems to grow from the root ball held by the plug holder 130 and ultimately exit the third volume 124 through an opening 126.

In operation, a fluid, such as water or a nutrient containing liquid, is introduced into the first volume 120 through an inlet 115 formed in the cap 104 by the first hose adapter 106. The fluid irrigates growing medium or plant roots contained in the first volume 120. Fluid which is not retained in the first volume 120 or consumed by the plant is prevented from entering the third volume 124 by the plug holder 130 to prevent or minimize moisture from contacting the plant stems and thus reduce the probability of mold or fungal growth, or the other disease vectors. The excess or unconsumed fluid travels from the first volume 120 to the second volume 122.

The second volume 122 is configured to hold the fluid for a desired period of time and provide a hydroponic growth region for roots of the plant which have propagated in a geotropic manner. If irrigation cycling is desired to simulate wet/dry environmental conditions or if the plant is sufficiently irrigated, the fluid may exit through a first outlet 136 formed in the base member 114 by the third hose adapter 108. Fluid released from the second volume 122 via the third hose adapter 108 is further controlled by a controller 142 in communication with a valve 140. The valve 140 may be a mechanical valve, such as a ball valve, gate valve, butterfly valve, or the like. The valve 140 may also be an electromechanical valve, such as a solenoid valve or the like. For example, tubing is connected to the third hose adapter and the valve 140 is disposed on the tubing. The controller 142, which may be in communication with a computer system and/or sensors, such as moisture sensors, hygrometers, or the like, determines when to empty the second volume 122 and opens the valve 140 to enable the fluid to exit the second volume 122. For example, a sensor may detect when a moisture level is above a predetermined set point in either the first volume 120 or the second volume 122 and the controller 142 opens the valve 140 to enable release of fluid from the second volume 122. The controller 142 may alternatively operate on a timing schedule to control fluid flow through the volume 120, 122.

A second outlet 119 is formed through the first wall 102 by the second hose adapter 110. The placement of the second hose adapter 110, which defines the position of the second outlet 119, is through the first wall 102 between the base member 114 and the first end 148 of the second wall 128. In the embodiment shown, the second outlet 119 is positioned adjacent to, but below the first end 148 of the second wall 128. The second outlet 119 functions as an overflow control to prevent fluid within the second volume 122 from backfilling into the first volume 120 above the plug holder 130. Accordingly, the second outlet 119 prevents or minimizes fluid from backing up in the first volume 120 and draining through the recess 132 of the plug holder 130. The second hose adapter 110 is also connected to a drain 138. The drain 138 connects to a fluid reservoir or the like which captures fluid exiting the second volume 122 through the second outlet 119. To conserve water or nutrient fluid, the drain 138 may be in fluid communication with the first volume 120. Water or nutrient fluid exiting the second outlet 119 may be delivered to the first inlet 115 via tubing and a pumping the water or nutrient fluid through the first hose adapter 106 and into the inlet 115. Thus, water or nutrient fluid may be recycled within the grow pot 100.

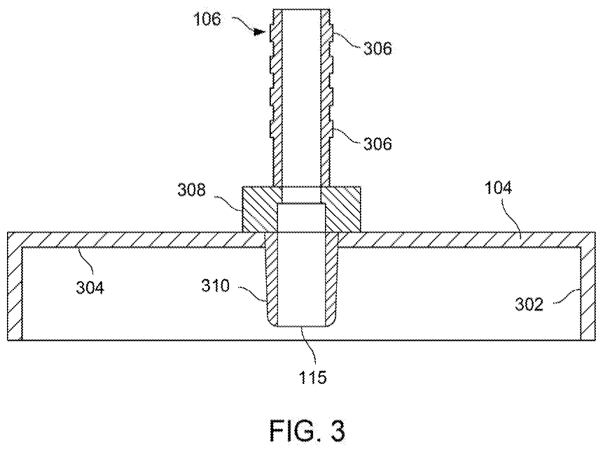

FIG. 3 illustrates a cross-sectional view of the cap 104 for the grow pot 100 of FIG. 1. The cap 104 includes a first member 304, such as a plate, disk, or other body, and a second member 302 which extends from the first member 304 in a substantially perpendicular direction. In the illustrated embodiment, the first member 304 and the second member 302 are formed integrally with one another. An inner diameter of the second member 302 is sized to be slightly larger than an outer diameter of the first wall 102. The second member 302 may be threaded to engage threads disposed on the first wall 102, thus enabling the cap 104 to be screwed onto the first wall 102.

The first hose adapter 106 extends through the first member 304 and includes a plurality of barbs 306 configured to engage tubing (not shown) coupled thereto. The tubing may extend over the barbs 306 and abut a block 308 from which the barbs 306 extend. The block 308 is disposed on the first member 304 and a tube 310 extends from the block 308 through the first member 304. The tube 310 may be press fit or screwed into the first member 304 to secure the block 308 against the first member 304. The inlet 115 is formed by the channel member 310 and has a diameter of between about 0.1 inches and about 1.0 inches, such as about 0.25 inches. In the embodiment shown, for example, the tube 310 extends a distance from the first member 304 less than a distance of the second member 302. Alternatively, the tube 310 may extend a distance from the first member 304 greater than a distance of the second member 302.

As described herein, the cap 104, first wall 102, second wall 128, and base member 114 are formed from one or more polymeric or plastic materials. In one embodiment, the materials utilized to form these components are opaque or sufficiently opaque to prevent light from entering the first volume 120 and the second volume 122. By preventing light from entering the volumes 120, 122, a dark environment suitable for root growth may be simulated to encourage vigorous plant growth and development. The third volume 124 may also be maintained substantially devoid of light. While some light may enter the third volume 124 through the opening 126, the materials of the cap 104, first wall 102, second wall 128, and base member 114 are selected to prevent undesirable amounts of light from entering the third volume. In such a dark or reduced light environment, stems of the plant are encouraged to grow and lignify without leafing, flowering, or fruiting within the third volume 124. Once the plant stem grows beyond the opening 126, light exposure is increased which influences the plant to leaf, flower, and fruit.

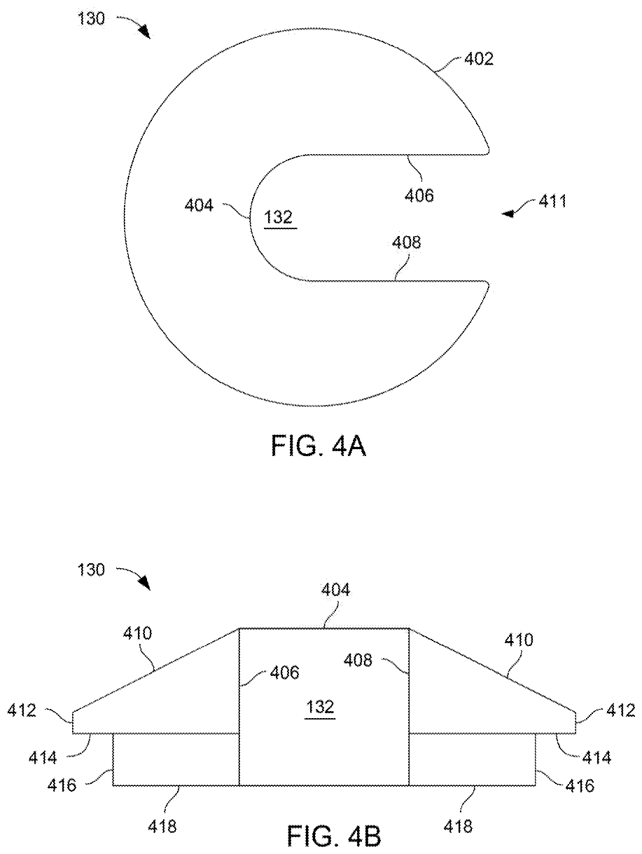

FIG. 4A is a plan view of a plug holder 130 of the grow 100 pot of FIG. 1. FIG. 4B illustrates a side view of the plug holder 130 of FIG. 4A. The plug holder 130, which includes the recess 132 formed therein, is adapted to hold a root ball or other mass of rooting material above or adjacent to a first surface 410 of body 402 of the plug holder 130 while a stem of the plant extends through the recess 132. In one embodiment, the body 402 of the plug holder 130 is substantially circular and the recess 132 extends radially inward into the body 402. The recess 132 forms an opening 411 in the body 402 which may be utilized to position a plant in the plug holder 130. While the plug holder 130 is described in detail hereinafter, it is contemplated that any apparatus, such as grommet or the like, having an opening through which stems can extend and capable of supporting a root ball may be beneficially utilized.

The body 402 includes the first surface 410 which defines a substantially frustoconical shape. The first surface 410 extends from the recess 132 radially outward to a first sidewall 412 of the body 402. More specifically, the first surface 410 extends radially outward to the first sidewall 412 from each of a fourth surface 406, fifth surface 408, and a sixth surface 404. Each of the fourth surface 406, fifth surface 408, and sixth surface 404 define the recess 132. The fourth surface 406 and the fifth surface 408 extend radially inward from each of the first sidewall 412 and a second sidewall 416. In one embodiment, the fourth surface 406 and the fifth surface 408 are substantially parallel to one another. Alternatively, the fourth surface 406 and the fifth surface 408 may be disposed in a non-parallel orientation with respect to one another. In both embodiments, the fourth surface 406 and the fifth surface 408 may be substantially linear. Alternatively, the fourth surface 406 and the fifth surface may be curvilinear or include a plurality of linear surfaces. The sixth surface 404 extends between the fourth surface 406 and the fifth surface 408. In one embodiment, the sixth surface 404 is curvilinear. In another embodiment, the sixth surface 404 approximates an arc of approximately 180°. In yet another embodiment, the sixth surface 404 may be one or more linear surfaces extending between the fourth surface 406 and the fifth surface 408. It is contemplated that various combinations of the aforementioned embodiments may be combined with one another without further recitation.

The plug holder 130 has a diameter of between about 0.5 inches and about 3 inches, such as between about 1 inch and about 2 inches, such as between about 1.25 inches and about 1.75 inches, for example, about 1.5 inches. It is contemplated that the diameter of the plug holder 130 may be dependent upon the diameter of the second walls 128 which are illustrated in detail in FIGS. 2, 5, and 6. The recess 132 extends from an outer diameter of the body 402 at the first sidewall 412 into the body 402 a length which is greater than a radius of the body 402 at the first sidewall 412. Alternatively, the recess 132 may extend from the outer diameter of the body 402 at the first sidewall 412 into the body 402 a length which is less than the radius of the body 402 at the first sidewall 412. The opening 411 at the first sidewall 412 of the body 402 has a width which is less than a radius of the body 402 at the first sidewall 412. Alternatively, the opening 411 at the first sidewall 412 of the body 402 has a width which is greater than a radius of the body 402 at the first sidewall 412. It is contemplated that the size and morphology of the opening 411 may be selected to accommodate a desired plant type disposed in the plug holder 130.

Each of the fourth surface 406, fifth surface 408, and sixth surface 404 have a length in a direction orthogonal to a radius of the body 402 which is substantially equal. For example, the fourth surface 406, fifth surface 408, and sixth surface 404 have substantially equal magnitudes and define a thickest portion of the body 402. More specifically, the fourth surface 406, fifth surface 408, and sixth surface 404 extend between a second surface 418 and the first surface 410 where the first surface 410 defines the recess 132. The second surface 418 is disposed opposite the first surface 410 and has a substantially planar orientation. As such, the first surface 410 is disposed at an angle with respect to the second surface 418. When exposed to water or a nutrient containing fluid, the frustoconical shape of the first surface 410 directs fluids away from the recess 132 to prevent or substantially reduce the probability of the fluid traversing through the recess 132.

A plurality of surfaces connect the first surface 410 and the second surface 418 outside of the recess 132. The first sidewall 412 extends from the first surface 410 toward the second surface 418 and is substantially parallel to each of the fourth surface 406, the fifth surface 408, and the sixth surface 404. A second sidewall 416 orthogonally extends from the second surface 418 toward the first surface 410 and is substantially parallel to the first sidewall 412, the fourth surface 406, the fifth surface 408, and the sixth surface 404. A third surface 414 extends between the first sidewall 412 and the second sidewall 416 and the third surface 414 is disposed substantially parallel to the second surface 418. The third surface 414 forms an overhang which enables the plug holder 130 to be disposed on and sit atop the first end 148 of the second wall 128. In this embodiment, the second sidewall 416 has a diameter which is less than an inner diameter of the second wall 128. In one embodiment, the first sidewall 412 has a diameter which is substantially equal to an outer diameter of the second wall 128. Alternatively, the first sidewall 412 may have a diameter which is greater than the outer diameter of the second wall 128. Thus, fluid traversing the first surface 410 is directed radially outward of the third volume 124 into the second volume 122 of the grow pot 100.

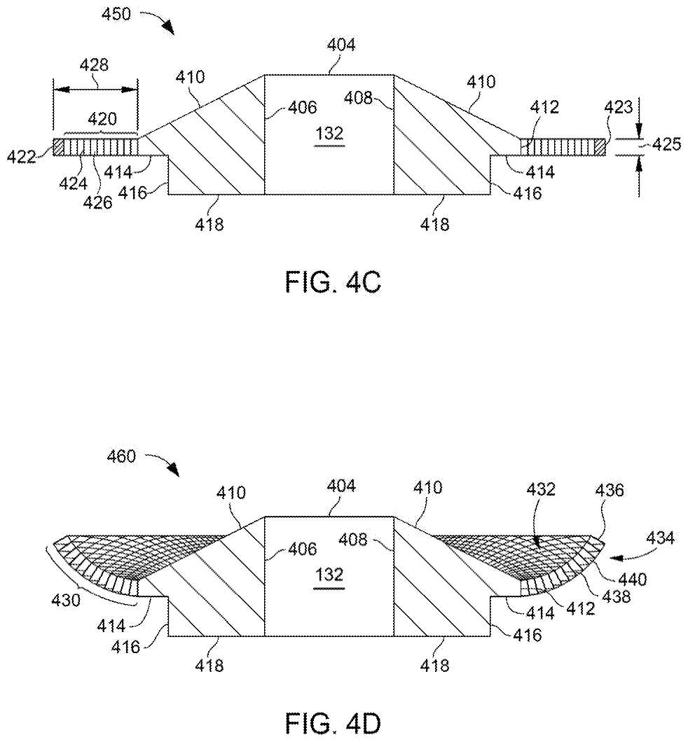

FIG. 4C illustrates a cross-sectional view of a plug holder 450. It is contemplated that the plug holder 450 may be utilized in place of the plug holder 130 depending upon the desired implementation. In the illustrated embodiment, a screen 420 is coupled to and extends from the first sidewall 412 of the plug holder 450. The screen 420 includes a mesh 424 of wires, fins, or the like which define a plurality of openings 426 therein. The screen 420 is disposed radially outward of the first sidewall 412 and extends laterally to a ring 422 which is coupled to and circumscribes the screen 420. The lateral extension of the screen 420 and ring 422 is above a plane defined by the third surface 414. The ring 422 functions as a frame which surrounds the screen 420 and provides structural rigidity or integrity to the screen 420 in order to support growth media above the screen. The screen 420 may function similarly to the screen 502 which is described in detail with regard to FIG. 5.

Within the grow pot 100, the screen 420 extends from the second wall 128 across at least a portion of the second volume 122. The ring 422, which is a solid block of material coupled to the screen 420, has a sidewall 423 which is configured to abut the first wall 102. A diameter of the sidewall 423 may approximate the inner diameter of the first wall 102. In one example, the screen 420 and ring 422 may define a boundary between the first volume 120 and the second volume 122. A width 428 of the screen 420 and ring 422 may approximate a width of the second volume 122. In one example, the width 428 may be between about 0.25 inches and about 1.25 inches, such as between about 0.5 inches and about 1.0 inch, for example, about 0.75 inches. A thickness 425 of the screen 420 and ring 422 approximates a thickness of the first sidewall 412. In one example, the thickness 425 of the screen 420 and ring 422 is less than about 1.0 inch, such as less than about 0.5 inches, such as less than about 0.25 inches. While the aforementioned examples describe the screen 420 and ring 422 as having a common thickness, it is contemplated that the screen 420 and ring 422 may have different thicknesses, depending upon the degree of structural integrity sufficient to support growth media thereon.

The screen 420 and the ring 423 are fabricated from the same materials as the plug holder 450. Alternatively, the screen 420 and the ring 422 may be fabricated from different materials than the plug holder 450. Advantageously, the screen 420 and ring 422 may be formed integrally with the plug holder 450 which increases the efficiency and ease with which the screen 420 can be removed from the grow pot 100. The integral formation of the screen 420 and ring 422 with the plug holder 450 improves cleaning efficiency of the screen 420 and the volumes 120, 122. Alternatively, the screen 420 and ring 422 may be detachably coupled to the plug holder 450. While the illustrated embodiments depict the screen 420 as coupled to and extending from the first sidewall 412, it is contemplated the screen 420 may be attached to the first surface 410 or the second sidewall 416 depending upon the desired implementation.

FIG. 4D illustrates a cross-sectional view of a plug holder 460. It is contemplated that the plug holder 460 may be utilized in place of the plug holder 130 depending upon the desired implementation. In the illustrated embodiment, a screen 430 is coupled to and extends from the first sidewall 412 of the plug holder 460. The screen 430 includes a mesh 438 of wires, fins, or the like which define a plurality of openings 440 therein. The screen 430 is disposed radially outward of the first sidewall 412 and extends in a lateral direction to an end 436 of the screen 430. The lateral extension of the screen 430 is above a plane defined by the third surface 414. The screen 420 functions to support growth media within the first volume 120 while allowing roots and fluid to pass through the screen 430.

The screen 430 has a first surface 432 and a second surface 434 disposed opposite the first surface 432. Because the screen 432 includes the mesh 438 with openings, the first surface 432 and the second surface 434 include the plurality of openings 440 which enable fluid communication between the first surface 432 and the second surface 434. In the illustrated embodiment, the first surface 432 is arcuate and curves from the first sidewall 412 to the end 436. Similar to the first surface 432, the second surface 434 is arcuate and curves from the first sidewall 412 to the end 436. As illustrated, the curvature of the first surface 432 and the second surface 434 are substantially parallel to one another. Each of the first surface 432 and the second surface 434 curve upward from the third surface 414 toward the sixth surface 404. Due to the curvature of the surfaces 432, 434, a magnitude of the first surface 432 in a radial direction is less than a magnitude of the second surface 434 in the radial direction.

In an alternate embodiment, the second surface 434 may curve in a direction inverse to the curvature of the first surface 432. In this embodiment, the second surface 434 curves downward from the third surface 414 toward the second surface 418 such that a thickness of the mesh 438 at the end 436 is greater than a thickness of the mesh 438 at the first sidewall 412.

Within the grow pot 100, the screen 430 extends from the second wall 128 across the second volume 122 and the end 436 is configured to abut the first wall 102. A diameter of the screen 430 at the end 436 may approximate the inner diameter of the first wall 102. Because the magnitudes of the first surface 432 and the second surface 434 are greater than a width of the second volume 122, the screen 430, without additional structural elements, is capable of supporting growth media thereon. In operation, the screen 430 may deform when growth media is supported, however, the curvature of the screen 430 enables frictional contact between the end 436 (and potentially the second surface 434) and the first wall 102 to prevent collapse of the screen 430 when the screen 430 is supporting growth media.

In one example, the screen 430 defines a boundary between the first volume 120 and the second volume 122. In the illustrated embodiment, a thickness of the screen 430 approximates a thickness of the first sidewall 412. In one example, the thickness of the screen 430 is less than about 1.0 inch, such as less than about 0.5 inches, such as less than about 0.25 inches. Alternatively, and as described above, a thickness of the screen 430 may increase in a radially outward direction when the curvature of the first surface 432 and the curvature of the second surface 434 are inverse to one another.

The screen 430 is fabricated from the same materials as the plug holder 460. Alternatively, the screen 430 may be fabricated from different materials than the plug holder 460. Advantageously, the screen 430 may be formed integrally with the plug holder 460 which increases the efficiency and ease with which the screen 430 can be removed from the grow pot 100. The integral formation of the screen 430 with the plug holder 460 improves cleaning efficiency of the screen 430 and the volumes 120, 122. Alternatively, the screen 430 may be detachably coupled to the plug holder 460. While the illustrated embodiment depict the screen 430 as coupled to and extending from the first sidewall 412, it is contemplated the screen 430 may be attached to the first surface 410 or the second sidewall 416, depending upon the desired implementation.

FIG. 5 illustrates a cross-sectional view of the grow pot 100 with a growth media 506 contained therein according to an embodiment of the disclosure. The growth media 506 is disposed within the first volume 120 of the grow pot 100. In one embodiment, the first volume 120 is entirely filled with growth media 506. In another embodiment, the amount of growth media 506 disposed in the first volume 120 is less than the entire volume of the first volume 120. In one embodiment, the growth media 506 utilized in the first volume 120 occupies greater than about 25% of the first volume 120, such as greater than about 50% of the first volume, such as greater than about 75% of the first volume 120. It is contemplated that the growth media 506 may also be disposed in some or all of the second volume 122. The growth media 506 may be any suitable plant growth media such as, but not limited to, soil, sand, peat, gravel, perlite, vermiculite, expanded shale, expanded clay, coconut husks, mineralwool, wood chips, organic matter, and combinations and mixtures thereof.

A first screen 502 is disposed between the first wall 102 and the second wall 128. In one embodiment, the first screen 502 extends between the first wall 102 and the second wall 128 at the first end 148 of the second wall 128. In another embodiment, the first screen 502 is disposed between the first wall 102 and the second wall 128 at a location spaced from the first end 148 of the second wall 128. The first screen 502 functions as a structuring element to support the growth media 506 disposed in the first volume 120 and to keep the second volume 122 substantially free of growth media 506. The first screen 502 is a mesh, grid, or other matrix of a material having sufficient structural integrity to support the growth media (in any state of saturation) thereon. The first screen 502 has openings formed therein which are sized to enable the passage of fluid therethrough but substantially prevent the passage of growth media 506 therethrough. In one example, the first screen 502 has a mesh or screen size with openings large enough to accommodate root growth therethrough while supporting the growth media 506.

A second screen 504 is disposed in the second volume 122 and extends between the first wall 102 and the second wall 128. In one embodiment, the second screen 504 is positioned adjacent to the first outlet 136 formed in the base member 114. In another embodiment, the second screen 504 is spaced from the first outlet 136 but remains adjacent to the second end 134 of the second wall 128. The second screen 504 functions to filter growth media 506 or other organic matter that may enter the second volume 122 and prevent or substantially reduce the probability of such material from clogging or otherwise obstructing the first outlet 136. As such, fluid present in the second volume 122 may freely flow through the first outlet 136 and the third hose adapted 108 when the valve 140 is opened. In one example, the openings in the second screen 504 are sized smaller than opening of the first screen 502. The combination of the first screen 502 and the second screen 504 enable sequentially finer screening of particulate materials while enabling fluid flow therethrough. When multiple grow pots are coupled together vertically, the screening of particulates minimizes the potential for clogging or fluid flow reduction when fluid flows from one pot to the next.

The material selected for the second screen 504 is the same material utilized for the first screen 502. It is contemplated that a mesh size for openings formed in the second screen 504 are the same size as the mesh size of openings of the first screen 502. In another embodiment, the mesh size for openings formed in the second screen 504 are smaller than the mesh size of opening of the first screen 502. In this embodiment, the first screen 502 and the second screen 504 function as a sequential screen to filter particulate matter and prevent or substantially reduce the probability of such matter from exiting the first outlet 136.

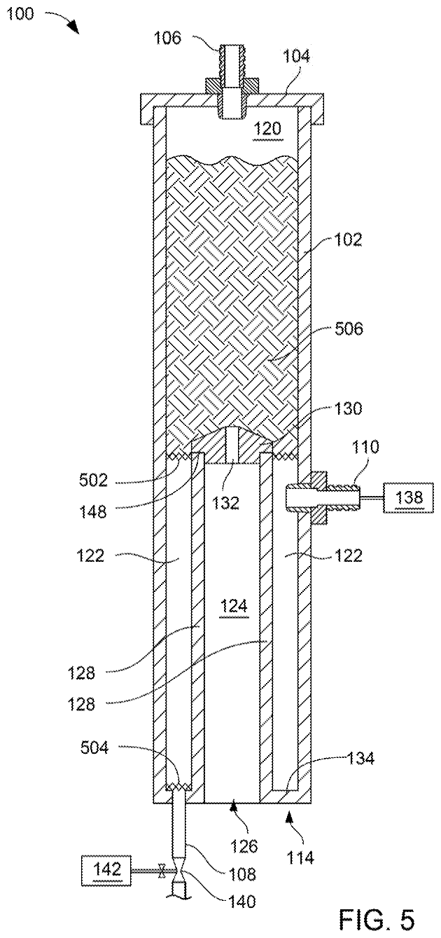

FIG. 6 illustrates a partial cross-sectional view of the grow pot 100 with a plant 600 disposed therein according to an embodiment of the disclosure. As illustrated, the plant 600 is disposed within the grow pot 100 in an orientation inverse to gravity. A root ball 602 of the plant 600 is disposed on and supported by the plug holder 130. Roots 604 of the plant 600 extend from the root ball 602 into one or both of the first volume 120 and the second volume 122. Advantageously, roots 604 which extend into the first volume 120 utilize the growth media contained therein for aerobic root growth. Roots 604 which exhibit geotropic development extend into the second volume 122 and obtain various benefits associated with aquatic root growth.

A stem 606 of the plant 600 grows from the root ball 602 through the recess 132 of the plug holder 130 and extends into the third volume 124. Because the third volume 124 is a dark or reduced light environment, the stem 606 is encouraged to grow away from the root ball 602 and lignify prior to branching. Near the opening 126, the stem 606 begins to form branches 608. It is contemplated that branching is encouraged by the increased amount of light at or near the opening 126. Upon exiting the opening 126, the stem 606 or branches 608 may further proliferate in a light environment which has an increase amount of light available for utilization when compared to the reduced light environment of the third volume 124. As such, the branches 608 may then produce leaves 612 and then flowers/fruit 610 beyond the opening 126.

Examples of plants which may be grown in the grow pot 100 include the Rubus genus of plants. Non-limiting examples of such plants include caneberries, such as raspberries, blackberries, dewberries, loganberries, boysenberries, marionberries, and tayberries, among other varietals. Other berry bushes which grow from a single stem may benefit from the grow pot 100. Other non-limiting plant examples include tomatoes and eggplants, among other fruit and vegetable crops. It is also contemplated that various dwarf tree varieties may be grown in and benefit from the grow pot 100.

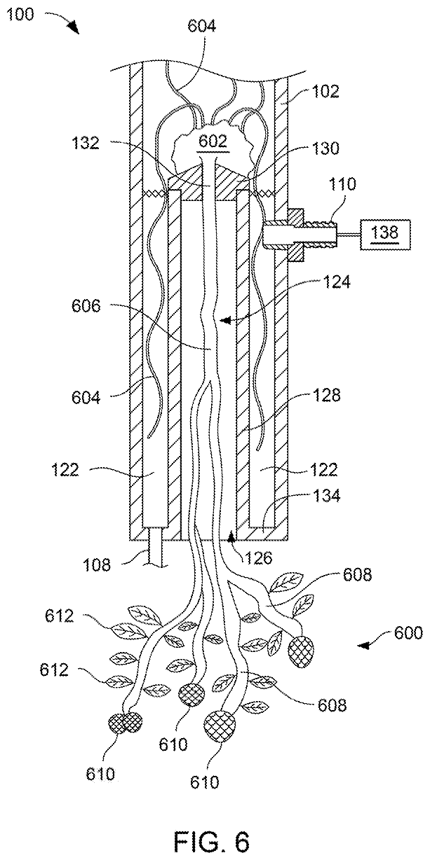

FIG. 7 illustrates a side view of multiple grow pots 100 arranged in a vertical architecture according to an embodiment of the disclosure. In one embodiment, the grow pots 100 are suspended from a superstructure, such as a grow line or the like, along which the pots 100 are translated through a plant propagation and growth system in an indoor controlled agricultural environment. The grow pots 100 are coupled to one another by one or more connectors 702. For example, the connectors 702 are attached or otherwise coupled between the second coupling elements 118 of the upper grow pot 100 and the first coupling elements 116 of the lower grow pot 100. Examples of connectors 702 which exhibit some degree of flexibility include wires, cables, and rope, or the like. Examples of connectors 702 which are rigid include rods, pins, and pipes, or the like. In embodiments utilizing a flexible material as the connectors 702, the connectors 702 are removably coupled to the coupling elements 116, 118 such that the ICI grow pots 100 are disconnected from one another during planting or cleaning operations. Alternatively, the grow pots 100 may remain coupled together by the connectors 702 during planting or cleaning operations. Similar to flexible connectors, embodiments utilizing a rigid material as the connectors 702 are also removably coupled to the coupling elements 116, 118.

In either embodiment, the type of connector 702 and coupling element 116, 118 are selected to interface with one another. For example, in an embodiment utilizing a metal cable as the connectors 702, the coupling elements 116, 118 include a groove about which the cable is looped and/or clamped. In an embodiment utilizing a rod, such as an allthread rod or the like, the coupling elements 116, 118 include a threaded hole through which the connectors 702 extend. It is also contemplated that a distance 706 between vertically adjacent grow pots 100 is adjustable by shortening or lengthening the connectors 702. The variable length of the distance 706 enabled by the utilization of the connectors 702 and the coupling elements 116, 118 provides for increased density of the grow pots 100 within a growing system or enclosure and the ability to increase the distance between grow pots 100 when the plants grow out of the grow pots 100.

For example, the distance 706 is relatively minimal when plants in the grow pots 100 are seedlings or don't extend out of the grow pots 100. When the plants grow out of the grow pots 100, the connectors 702 are lengthened, and thus the distance 706 increased, to prevent crowding of the plants and to provide sufficient space for plant proliferation. Alternatively, the distance 706 may remain fixed during plant propagation.

In another embodiment, the connectors 702 are springs. In this embodiment, springs are either an extension spring or a torsion spring. Utilization of a spring for the connectors 702 enables the distance 706 between grow pots 100 to self-adjust based upon the amount of growing media, fluid, and biomass contained within each grow pot 100. For example, the spring's rate of extension is selected to be influenced by the amount of biomass of the plant. When a plant is young, the plant contributes a relatively small amount of mass to the spring and the amount of deflection of the spring is minimal. As the plant grows, the amount of biomass the plant has increases and thus the increase in weight imparts an increased force on the spring causing the spring to increase the amount of deflection or extension. It is contemplated that the spring's force for each of the connectors 702 between vertically aligned grow pots 100 may be different as the weight imparted upon each connector 702 is increased at an uppermost connector when compared to a lowermost connector in a plurality of vertically aligned grow pots 100.

Tubing 704 is also connected between adjacent grow pots 100 in a vertically aligned architecture. The tubing 704 extends between the third hose adapter 108 of an upper grow pot 100 and the first hose adapter 106 of a lower grow pot 100. In operation, fluid exiting the second volume 122 of an upper grow pot 100 via the outlet 136 traverses through the third hose adapter 108, the tubing 704, the first hose adapter 106 of a lower grow pot 100, and enters the first volume 120 of the lower grow pot 100. Thus, the tubing 704 enables sequential fluid and nutrient transfer between vertically disposed grow pots 100. Although not illustrated, one or more inlets or ports may be formed in the tubing 704 to enable introduction of fluid or nutrients within the vertically aligned grow pot system. In this embodiment, fluid or nutrients are introduced into the tubing 704 which have not previously traversed through a grow pot 100. The additional fluid or nutrients are used to supplement any fluid or nutrients entering a grow pot from an above grow pot.

Fluid transfer between grow pots 100 according to the embodiments described herein eliminates or reduces the amount of fluid utilized to irrigate plants grown in the grow pots 100 and reduces irrigation plumbing complexity by eliminating individual irrigation lines to each grow pot 100 in the vertical architecture. For example, a plurality of grow pots 100 disposed in a vertical architecture are irrigated from a single irrigation source point, for example, at the uppermost grow pot 100 in a vertical architecture having a plurality of grow pots 100.

In one embodiment, the tubing 704 is fabricated from a polymeric material. The polymeric material is flexible and capable of obtaining a plurality of spatial orientations or morphologies. In one example, the tubing 704 is coiled flexible tubing. In this example, the tubing 704 is capable of spanning or otherwise traversing the distance 706, which may be varied by the connectors 702. Thus, irrigation between vertically adjacent grow pots 100 is maintained even when the distance 706 changes. In addition, the tubing 704 is adapted to receive fluid exiting the second outlet 119 via the second hose adapter 110. In this embodiment, a T is placed in the tubing 704 and any overflow fluid from the second volume 122 would traverse through the tubing 704 into the first volume 120 of the lower grow pot 100. Thus, water conservation and irrigation efficiency may be improved.

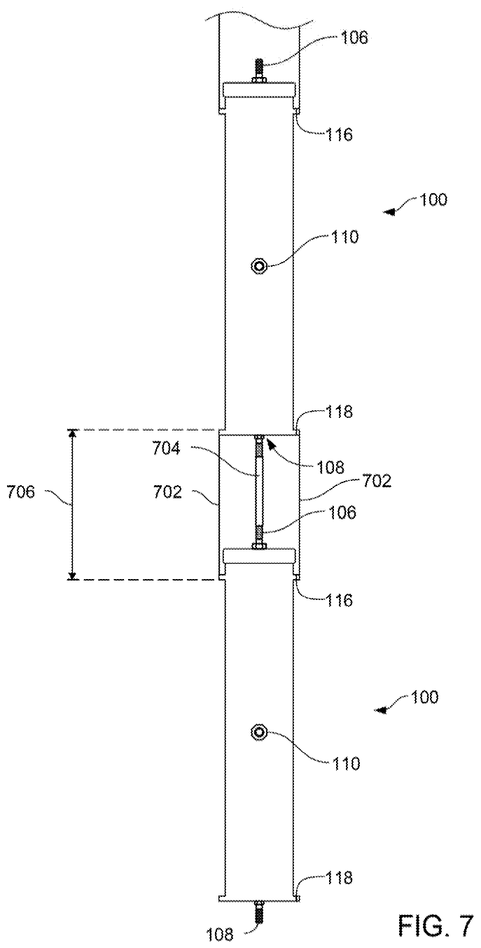

FIG. 8 illustrates a side view of multiple grow pots 100 arranged in a vertical architecture with a load cell 802 between the grow pots according to an embodiment of the disclosure. Although only two grow pots 100 are shown, it is contemplated that multiple additional grow pots 100 and load cells 802 may be implemented within a single vertical string architecture. It is further contemplated that different types of grow pots beyond those described herein may be implemented in a similar vertical architecture with load cells disposed between adjacent grow pots in the vertical architecture.

The load cell 802 is disposed between the base member 114 of an upper ICI grow pot 100 and a cap 104 of a lower ICI grow pot 100. If the cap 104 is not present, the load cell 802 is coupled to the first end 112 of the ICI grow pot 100. In one embodiment, the load cell 802 is coupled to the base member 114 of the upper ICI grow pot 100 by a first connector 804 and the load cell 802 is coupled to the cap 104 of the lower ICI grow pot 100 by a second connector 806. In one embodiment, the connectors 804, 806 are fabricated from a material having a relatively low elastic modulus. For example, the connectors 804, 806 are a cable, wire, rod, post, allthread, or other similar morphology configured to support and position the load cell 802 between the grow pots 100 when the grow pots 100 are disposed in a vertically stacked orientation. Materials suitable for fabricating the connectors 804, 806 include metallic materials, polymeric materials, and other materials suitable for utilization in the form factors described herein. In embodiments utilizing connectors 804, 806, made from materials having a relatively low elastic modulus, it is contemplated that the distance 706 will remain substantially constant during grow of plants in the grow pots 100.

Alternatively, the connectors 804, 806 are fabricated from a material having an increased elastic modulus. For example, the connectors 804, 806 are springs, elastic bands, bungee cords, or the like which extend to increase the distance 706 as the weight of the grow pot 100 increases or decreases. In one embodiment, the elastic modulus of the material selected for the connectors 804, 806 is selected to extend a known distance based upon average weights of the grow pots 100 during grow cycles of plants disposed in the grow pots 100. For example, the material of the connectors 804, 806 is selected to elastically deform over time as the plant in the pot 100 grows and gains biomass to increase the distance 706 and enable sufficient room outside of the grow pot 100 for plant growth.

The load cell 802, which is coupled to and between the connectors 804, 806, “sees” substantially the entire weight of the grow pot 100 disposed below the load cell 802. Thus, the load cell 802 is configured to measure the force applied to the load cell 802 by the grow pot disposed below the load cell 802. In one embodiment, the load cell 802 is a tension-type load cell. The load cell 802 may also be a hydraulic, pneumatic, piezoelectric, or strain gauge type load cell. Examples of suitable load cells include S-type tension load cells, tension link type load cells, canister type tension load cells, or pancake type tension load cells.

In one embodiment, the load cell 802 includes a strain gauge. In this embodiment, the load cell 802 includes a metallic body which exhibits minimal elasticity which can be considered a spring element. As force is exerted on the metallic body, the spring element of the body is deformed. A strain gauge, which may be a wire or foil, typically coupled to the body by a flexible backing material, either elongates, compresses, or otherwise deforms in response to deformation of the spring element. In one embodiment, the strain gauge is a wheatstone bridge or the like. The strain gauge measures changes in the force via a change in electrical resistance which can then be standardized as a weight, for example, a weight of the grow pot 100 (or multiple grow pots) disposed below the load cell 802.

An irrigation connector 808 is disposed between the grow pots 100. The irrigation connector 808 is a hollow member which functions as a conduit to transfer fluids/nutrients from an upper grow pot 100 to a lower grow pot 100 in the vertical architecture. The irrigation connector 808 is formed from one or more materials, such as polymeric materials or the like. In one embodiment, the irrigation connector 808 is fabricated from the same or similar material as the wall 102 of the grow pot 100. In another embodiment, the irrigation connector 808 is fabricated from the same material as the tubing 704. In embodiments where the irrigation connector 808 is of a form factor and/or material which is capable of elongation or elasticity, the irrigation connector 808 is capable of changing the distance 706 between the grow pots 100 to accommodate plant growth in the region between the pots 100.

In one example, the irrigation connector 808 is coupled to and extends from the base member 114 of a grow pot 100 disposed above the irrigation connector 808. In one embodiment, a first portion 810 of the irrigation connector 808 is coupled to the base member 114 at the first outlet 136 of the grow pot 100 disposed above the irrigation connector 808. The first portion 810 is funnel shaped or otherwise shaped to interface with the base member 114 and collect fluid from the upper grow pot 100 via the first outlet 136. The first portion 810 of the irrigation connector 808 is connected to a second portion 812 and the second portion 812 is coupled to a third portion 814.

The second portion 812 is shaped to accommodate the presence of the load cell 802 and connectors 804, 806 disposed between the grow pots 100. For example, the second portion 812 extends from the first portion 810 such that the second portion 812 is disposed out of plane with a central vertical axis of the grow pots 100. The third portion 814 extends from the second portion 812 and connects to the grow pot 100 disposed below the irrigation connector 808. In one example utilizing the cap 104, the third portion 814 is coupled to the hose adapter 106 or the inlet 115. In embodiments, where the cap 104 is not utilized, the third portion 814 is coupled to the wall 102 at or adjacent to the first end 112 such that the third portion 814 is positioned to deliver fluid and/or nutrients to the first volume 120.

In another example, the irrigation connector 808 is also coupled to and extends from the cap 104 of a grow pot disposed below the irrigation connector 808. In embodiments where the cap 104 is not utilized, the irrigation connector 808 is coupled to the wall 102 adjacent to or at the first end 112 of the grow pot disposed below the irrigation connector 808. The irrigation connector 808 enables fluid transfer in a multiple-grow pot vertical architecture system while accommodating incorporation of load cells 802 between the grow pots 100 to measure a weight of each of the grow pots 100. The irrigation connector 808 may also elongate or contract if the distance 706 between the grow pots 100 changes.

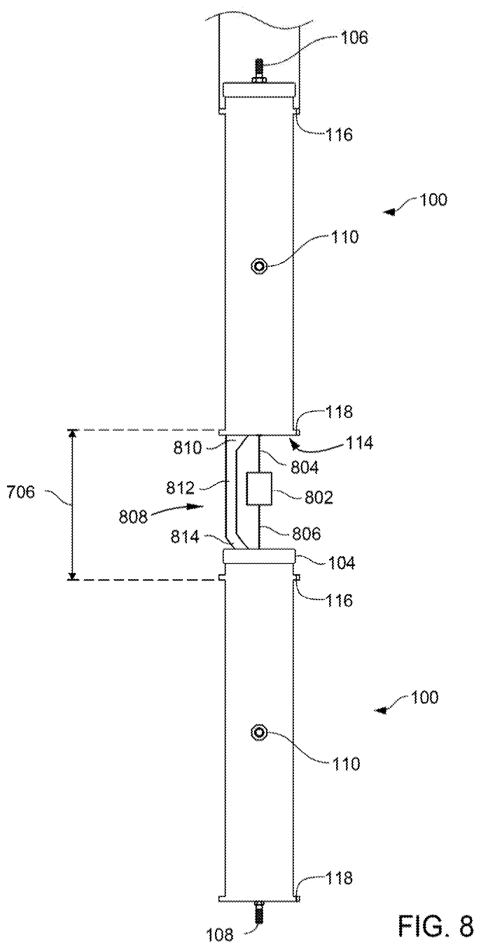

FIG. 9A illustrates a side view of multiple grow pots 100 with a support member 900 according to an embodiment of the disclosure. The grow pots 100 are connected together in a vertical arrangement by the support member 900. The support member 900 enables movement of the grow pots 100 relative to one another in plane with a major axis (vertical) of the support member 900. The support member 900 also substantially prevents or reduces the probability of lateral or torsional movement of the grow pots 100 relative to one another. The support member 900 is also configured to accommodate the incorporation of a load cell in a vertical grow pot architecture. Although not illustrated, it is contemplated that the support member 900 may be beneficially incorporated into any of the vertical grow pot system architectures described and illustrated with respect to FIGS. 7, 8, 10, 11A, 11B, 12A, 12B, and 12C.

The support member 900 is coupled between two grow pots, for example, an upper grow pot 100 and a lower grow pot 100. The support member 900 is attached to the upper grow pot 100 by one or more first fasteners 908 and to the lower grow pot 100 by one or more second fasteners 910. The fasteners 908, 910 are screws, bolts, rivets, or the like. The support 900 includes a first portion 902, a second portion 904 disposed opposite the first portion 902, and a third portion 906 disposed between the first portion 902 and the second portion 904. In one example, the first portion 902 is coupled to the upper grow pot 100 and the second portion 904 is coupled to the lower grow pot 100. The first portion 902 extends from the third portion 906 to a first end 912 and the second portion 904 extends from the third portion 906 to a second end 914.

In one embodiment, the first end 912 of the support 900 is coupled to the upper grow pot 100 adjacent to and below the second hose adapter 110. The second end 914 of the support is coupled to the lower grow pot 100 adjacent to and above the second hose adapter 110. The third portion 906 is disposed between the upper and lower grow pots 100 and approximates the distance 706. The third portion 906 includes an accordion shaped morphology having a plurality of folds. The support 900 is fabricated from a polymeric material, such as a thermoplastic material or the like. The material is also selected to exhibit elasticity.

For example, the accordion or folded morphology of the third portion 906 is configured to extend when a weight of the lower grow pot 100 is increased, thus increasing the distance 706 between the upper and lower grow pots 100. However, when the weight of the lower grow pot 100 is decreased, the third portion 906 exhibits elasticity and the third portion 906 is capable of recoiling to reduce the distance 706. In other words, the third portion 906 exhibits a spring-like reaction and the displacement of the third portion 906 is reduced when a weight of the lower grow pot 100 is decreased. It is contemplated that the distance 706 between the grow pots 100 will gradually increase via extension of the third portion 906 as biomass of plants in the lower grow pot 100 increases, thus providing more space for plant growth between the upper and lower grow pots 100.

FIG. 9B illustrates a schematic, cross-sectional view of the support member 900 of FIG. 9A according to an embodiment of the disclosure. In the illustrated embodiment, the cross-section is taken along a major axis of the support 900 to illustrate the accordion or folded morphology of the third portion 906. This embodiment also illustrates an example of the support member being substantially planar. In one example, a planar support 900 is utilized when the grow pots 100 have a substantially quadrilateral shape. FIG. 9C illustrates a schematic, end view of the support member 900 of FIG. 9A according to an embodiment of the present disclosure. In the illustrated embodiment, the support 900 has a radius of curvature. In one embodiment, the radius of curvature of the support is similar to a radius of curvature of an outer diameter of the grow pot 100. In various embodiments, the support 900 has a ⅛ arc, a ¼ arc, a ⅜ arc, a ½ arc, a ⅝ arc, a ¾ arc, or a ⅞ arc. In one example, the support 900 exhibiting a radius of curvature is utilized when the grow pots 100 are cylindrical. Thus, the support 900 is shaped to match the shape of the grow pots 100.

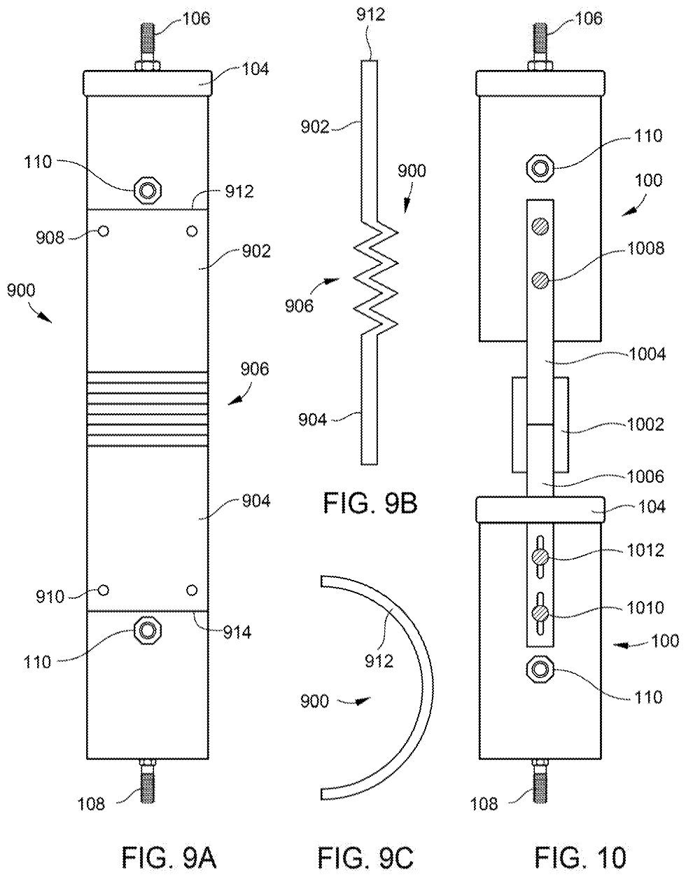

FIG. 10 illustrates a side view of multiple ICI grow pots 100 arranged in a vertical architecture with a load cell 1002 between the grow pots 100 according to an embodiment of the disclosure. In the illustrated embodiment, the grow pots 100 are structured and spaced apart from one another by a first connector 1004 and a second connector 1006. The connectors 1004, 1006 are coupled together at the load cell 1002. In one embodiment, the connectors 1004, 1006 are coupled to the load cell 1002 which at least partially surrounds the connectors 1004, 1006 where the connectors 1004, 1006 abut one another. In another embodiment, the load cell 1002 is disposed between the connectors 1004, 1006 and the connectors 1004, 1006 are coupled to the load cell 1002. The connectors 1004, 1006 are fabricated from any suitable material, such as a polymeric material, a metallic material, or the like. The connectors 1004, 1006 provide support to and suspend the lower grow pot 100 from the upper grow pot 100. The connectors 1004, 1006 are formed with various shapes, such as rods, plates, beams, or the like.

The first connector 1004 is coupled to the upper grow pot 100 by one or more first fasteners 1008. The first fasteners 1008 are screws, bolts, rivets or the like operable to fixably couple the first connector 1004 to the upper grow pot 100. The second connector 1006 is coupled to the lower grow pot 100 by one or more second fasteners 1010. An opening 1012 is formed in the second connector 1006 for each of the second fasteners 1010. In one embodiment, the opening 1012 is an elongated opening having a major axis oriented parallel to a major axis of the second connector 1006. The second fasteners 1010 extend through the opening 1012 and engage the lower grow pot 100 but are stood off from the second connector 1006 to enable movement of the lower grow pot 100 relative to the second connector 1006. Alternatively, the second fasteners 1010 engage the second connector 1006 and tightly secure the second connector 1006 to the lower grow pot 100. In one embodiment, the distance 706 between the grow pots 100 is increased or decreased by moving the lower grow pot 100 upward or downward relative to the openings 1012 and then securing the second fasteners 1010 with the lower grow pot 100 in a desired position relative to the upper grow pot 100.

In one example, when the lower grow pot 100 is irrigated or when the biomass of a plant growing in the lower grow pot 100 increases, the weight of the lower grow pot 100 similarly increases. The increase in weight of the lower grow pot 100 is sensed or otherwise detected by the load cell 1002. In one embodiment, the load cell 1002 is a tension-type load cell. Examples of tension-type load cells include, but are not limited to, a tension link type load cell, a pancake type load cell, a canister type load cell, and an S-type load cell, among others.

The load cell 1002 may also be a hydraulic, pneumatic, piezoelectric, or strain gauge type load cell. In one embodiment, the load cell 1002 includes a strain gauge. In this embodiment, the load cell 1002 includes a metallic body which exhibits minimal elasticity which can be considered a spring element. As force is exerted on the metallic body, the spring element of the body is deformed. A strain gauge, which may be a wire or foil, typically coupled to the body by a flexible backing material, either elongates, compresses, or otherwise deforms in response to deformation of the spring element. In one embodiment, the strain gauge is a wheatstone bridge or the like. The strain gauge measures changes in the force via a change in electrical resistance which can then be standardized as a weight, for example, a weight of the lower grow pot 100.

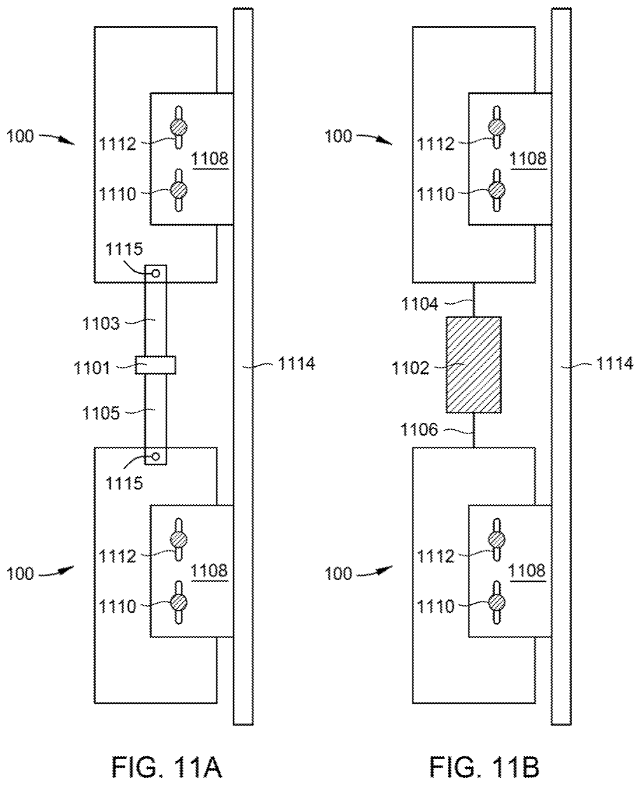

FIG. 11A illustrates a side view of multiple ICI grow pots 100 arranged in a vertical architecture with a load cell 1101 between the grow pots 100 according to an embodiment of the present disclosure. Similar to the embodiments of FIG. 10, two grow pots 100 are structured with respect to one another by a first connector 1103 coupled to the upper grow pot 100, a second connector 1105 coupled to the lower grow pot 100, and a load cell 1101 disposed between the connectors 1103, 1105. It is contemplated that the connectors 1004, 1006 are similar to the connectors 1103, 1105. The connectors 1103, 1105 are coupled directly to the upper and lower grow pots 100, respectively, by one or more fasteners 1115. The fasteners 1115 are similar to the fasteners 1008, 1010.

The grow pots 100 are coupled to a column 1114 by brackets 1108. The brackets 1108 are fixably coupled to the column 1114 and extend laterally outward from the column 1114. Each of the brackets 1108 includes one or more openings 1112 and the grow pots 100 are coupled to the brackets 118 by fasteners 1110. It is contemplated the openings 1112 and fasteners 1110 are similar to the openings 1012 and fasteners 1010. In one embodiment, the upper grow pot 100 is fixedly coupled to the bracket 1108. In this embodiment, the lower grow pot 100 is coupled to the bracket 1108, but the fasteners 1110, although coupled to the lower grow pot 100, are not fastened tightly and act as guides within the openings 1112. For example, the lower grow pot 100 is slidably coupled to the bracket 1108. In this embodiment, the load cell 1101 is a tension-type load cell and the weight of the lower grow pot 100 is measured by the load cell 1101.

In an alternate embodiment, the lower grow pot 100 is fixedly coupled to the bracket 1108. In this embodiment the upper grow pot 100 is coupled to the bracket 1108, but the fasteners 1110, although coupled to the upper grow pot 100, are not fastened tightly and act as guides within the openings 1112. For example, the upper grow pot 100 is slidably coupled to the bracket 1108. In this embodiment, the load cell 1101 is a compression-type load cell and the weight of the upper grow pot 100 is measured by the load cell 1101. In this embodiment, the load cell 902 may also be a hydraulic, pneumatic, piezoelectric, or strain gauge type load cell. Examples of suitable load cells include S-type compression load cells, canister type compression load cells, or pancake type compression load cells.

In one embodiment, the load cell 1101 includes a strain gauge. In this embodiment, the load cell 1101 includes a metallic body which exhibits minimal elasticity which can be considered a spring element. As force is exerted on the metallic body, the spring element of the body is deformed. A strain gauge, which may be a wire or foil, typically coupled to the body by a flexible backing material, either elongates, compresses, or otherwise deforms in response to deformation of the spring element. In one embodiment, the strain gauge is a wheatstone bridge or the like. The strain gauge measures changes in the force via a change in electrical resistance which can then be standardized as a weight, for example, a weight of the upper grow pot 100.

In either of the aforementioned embodiments, the column 1114 functions to provide additional structure and support for the grow pots 100. In one embodiment, the column 1114 is stationary. For example, the column 1114 is fixed to the floor of a controlled indoor agriculture environment. In another embodiment, the column 1114 is suspended from a superstructure above the column 1114. For example, the column 1114 is coupled to or otherwise supported or suspended from an overhead grow line. In certain embodiments, the column 1114, and thus, the grow pots 100, are translatable or otherwise moveable along the grow line or other superstructure.

FIG. 11B illustrates a side view of multiple grow pots 100 arranged in a vertical architecture with a load cell 1102 between the grow pots 100 according to an embodiment of the present disclosure. The embodiment of FIG. 11B is similar to certain embodiments of FIG. 11A, however, the type of connectors 1104, 1106 implemented are different. In the embodiment of FIG. 11B, the upper grow pot 100 is fixably coupled to the bracket 1108. A first connector 1104 is coupled to the upper grow pot 100 and a second connector 1106 is coupled to the lower grow pot 100. The load cell 1102 is coupled between the first and second connectors 1104, 1106. In this embodiment, the load cell 1102, is a tension type load cell such as that described with respect to FIG. 10 configured to detect and measure the weight of the lower grow pot 100.

In one embodiment, the connectors 1104, 1106 are a wire, rope, cord, allthread, or other similar element. In one embodiment, the connectors 1104, 1106 are springs. In another embodiment, the connectors 1104, 1106 are fabricated from a material which exhibits elasticity, such as a bungee cord, rubber material, or other similar material. In embodiments utilizing connectors which exhibit elasticity, a distance, such as the distance 706, between the upper and lower grow pots 100 is capable of changing based upon the weight of the lower grow pot 100. In such an embodiment, increased spacing between the grow pots 100 is enabled as a result of the connector's elasticity due to the increase in biomass of plants in the lower grow pot 100 exerting additional force on the connectors 1104, 1106.

Similar to the embodiments described with respect to FIG. 11A, the column 1114 functions to provide additional structure and support for the grow pots 100. In one embodiment, the column 1114 is stationary. For example, the column 1114 is fixed to the floor of a controlled indoor agriculture environment. In another embodiment, the column 1114 is suspended from a superstructure above the column 1114. For example, the column 1114 is coupled to or otherwise supported or suspended from an overhead grow line. In certain embodiments, the column 1114, and thus, the grow pots 100, are translatable or otherwise moveable along the grow line or other superstructure.

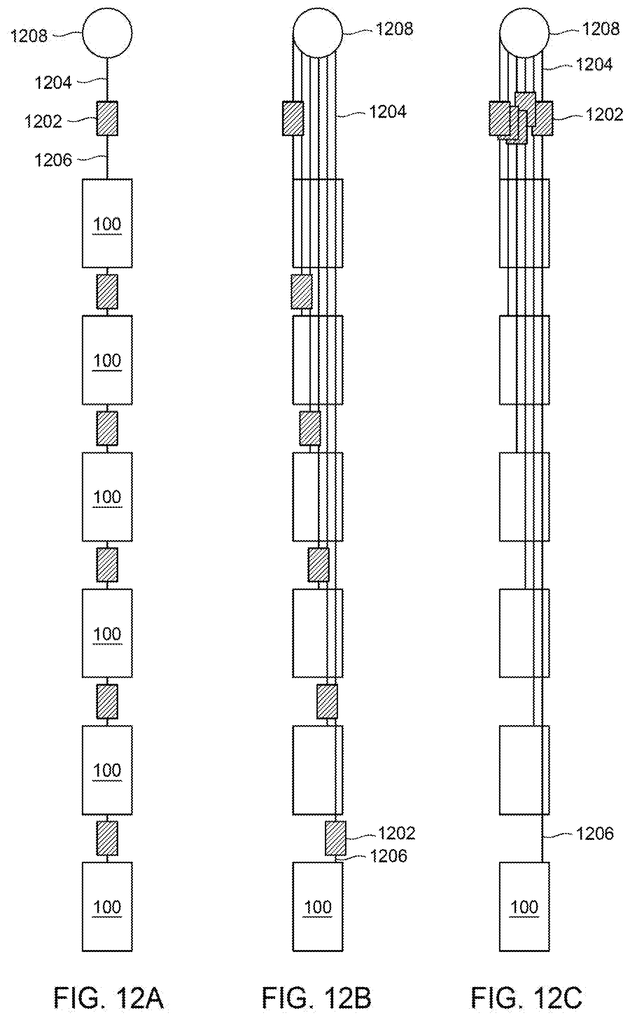

FIG. 12A illustrates a grow pot system incorporating load cells 1202 according to an embodiment of the present disclosure. The system includes a superstructure 1208, such as an overhead grow line or other structure from which the grow pots 100 are suspended. A plurality of grow pots 100 are suspended from the superstructure 1208. In one embodiment, a first connector 1204 is coupled to the superstructure 1208, a load cell 1202 is coupled to the first connector 1204, and a second connector 1206 is coupled between the load cell 1202 and a grow pot 100. In one embodiment, a length of each of the connectors 1204, 1206 within the system is equal or substantially equal. The connectors 1204, 1206 are any type of connector described in the aforementioned embodiments. In one embodiment, the connectors 1204, 1206, are a wire, rope, cord, or allthread type connector. In another embodiment, the connectors 1204, 1206 are either a spring or fabricated from a material which exhibits a desired degree of elasticity.

The system includes a plurality of additional connectors 1204, 1026, load cells 1202, and grow pots 100, wherein each succeeding grow pot 100 is suspended from an above grow pot 100 by the connectors 1204, 1206. The load cells 1202 are disposed between each subsequent grow pot 100 down the chain or sequence of grow pots 100. In this embodiment, the load cells 1202 are tension-type load cells such as those described with respect to FIG. 10. The load cells 1202 are operable to detect and measure force applied thereon for each grow pot 100 in the system. As such, a weight determination of individual grow pots 100, as well as a weight of the entire system, is enabled.

FIG. 12B illustrates a grow pot system incorporating the load cells 120 according to an embodiment of the present disclosure. The system of FIG. 12B is similar to that of FIG. 12A, however, a plurality of first connectors 1204 is coupled to the superstructure 1208 and each of the first connectors 1204 have different and varying lengths. The second connectors 1206 are coupled between the load cells 1202 and the grow pots 100 and have the same or a similar length. In this embodiment, each of the load cells 1202 is positioned two grow pots 100 in the descending sequence of grow pots 100. Similar to the system of FIG. 12A, the load cells 1202 are operable to detect and measure force applied thereon for each grow pot 100 in the system. As such, a weight determination of individual grow pots 100, as well as a weight of the entire system, is enabled.

FIG. 12C illustrates a grow pot system incorporating the load cells 1202 according to an embodiment of the present disclosure. The system of FIG. 12C is similar to that of FIG. 12B in that the plurality of first connectors 1204 is coupled to the superstructure 1208, however, each of the second connectors 1206 have different and varying lengths. The first connectors have the same or a similar length and are coupled to the load cells 1202. The load cells 1202 are disposed between the uppermost grow pot 100 and the superstructure 1208 of the system. The second connectors 1206 vary in length and position the grow pots 100 within the descending sequence of grow pots 100. Similar to the systems of FIGS. 12A and 12B, the load cells 1202 are operable to detect and measure force applied thereon for each grow pot 100 in the system. As such, a weight determination of individual grow pots 100, as well as a weight of the entire system, is enabled.

Exemplary implementations of the disclosure are described herein and may be combined with one another without further recitation.

In one implementation, a plant pot apparatus includes a first wall having a first end and a second end, a second wall having a first end and a second end, the second wall disposed radially inward of the first wall, a base member extending between the second end of the first wall and the second end of the second wall, a first outlet formed through the base member, a second outlet formed through the first wall, and a plug holder coupled to the first end of the second wall.

The apparatus according to any one of the previous implementations and further comprising a cap coupled the first end of the first wall, the cap having an inlet formed therein.

The apparatus according to any one of the previous implementations wherein the plug holder comprises a body having a first surface and a second surface opposing the first surface and a recess formed in the body, the recess extending from the first surface to the second surface.

The apparatus according to any one of the previous implementations wherein the first surface of the body is disposed in a non-parallel orientation to the second surface of the body.

The apparatus according to any one of the previous implementations wherein the plug holder further comprises a first sidewall extending from the first surface, a second sidewall extending from the second surface, and a third surface extending between the first sidewall and the second sidewall.

The apparatus according to any one of the previous implementations wherein the first sidewall is disposed radially outward of the second sidewall.

The apparatus according to any one of the previous implementations wherein the recess formed in the body is defined by a fourth surface and a fifth surface, wherein the fourth surface and fifth surface are oriented substantially parallel to one another, and wherein a curvilinear sixth surface extends between the fourth surface and the fifth surface.

The apparatus according to any one of the previous implementations wherein the first wall defines a first volume which extends between the cap and the plug holder.

The apparatus according to any one of the previous implementations wherein the first volume is substantially cylindrical.

The apparatus according to any one of the previous implementations wherein the first wall and the second wall define a second volume which extends between the plug holder and the base member.

The apparatus according to any one of the previous implementations wherein the second volume is substantially annular.

The apparatus according to any one of the previous implementations wherein the second wall further defines a third volume disposed radially inward of the second wall, the third volume extending from the plug holder to the base member.

The apparatus according to any one of the previous implementations wherein a length of the first wall is between about 1.5 and about 3 times greater than a length of the second wall.

The apparatus according to any one of the previous implementations wherein a length of the second wall is between about 5 inches and about 15 inches.

The apparatus according to any one of the previous implementations further comprising a first screen extending between the first wall and the second wall, wherein the screen is coupled to the second wall adjacent to the first end of the second wall.

The apparatus according to any one of the previous implementations wherein the first screen is substantially annular.

The apparatus according to any one of the previous implementations further comprising a second screen extending between the first wall and the second wall adjacent to the first outlet formed through the base member.

The apparatus according to any one of the previous implementations wherein the second outlet is formed through the first wall between the second end of the first wall and the first end of the second wall.

The apparatus according to any one of the previous implementations further comprising growth media disposed in the first volume.

In another implementation a plant pot apparatus includes a cylindrical first wall having a first radius and a first length, a cylindrical second wall having a second radius and a second length less than the first radius and the first length, respectively, a base member extending between the cylindrical first wall and the cylindrical second wall, a cap coupled to the cylindrical first wall opposite the base member, and a plug holder coupled to the cylindrical second wall between the cap and the base member.

The apparatus according to any one of the previous implementations wherein the first length is between about 1.5 and about 3 times greater than the second length.

The apparatus according to any one of the previous implementations wherein the cap further comprises a hose barb adapter centrally disposed through the cap.

The apparatus according to any one of the previous implementations wherein the base member further comprises a hose barb adapter disposed through the base member.

The apparatus according to any one of the previous implementations further comprising a hose barb adapter disposed through the cylindrical first wall.

The apparatus according to any one of the previous implementations wherein the cylindrical first wall at least partially defines a first volume and the cylindrical second wall at least partially defines a second volume, and wherein the first volume and second volume are in fluid communication with one another.

The apparatus according to any one of the previous implementations wherein the first volume is substantially cylindrical and the second volume is substantially annular.

The apparatus according to any one of the previous implementations further comprising a third volume at least partially defined by the cylindrical second wall, wherein the third volume is in fluid communication with the first volume via a recess of the plug holder.

The apparatus according to any one of the previous implementations wherein the plug holder comprises a body having a recess formed therein, the body comprising a sloped surface extending from the recess to a first sidewall, a planar surface disposed opposite the sloped surface in a non-parallel orientation, a first sidewall extending from the sloped surface, and a second sidewall extending from the planar surface, wherein the second sidewall is disposed radially inward of the first sidewall.

The apparatus according to any one of the previous implementations wherein the recess extends through the body from the sloped surface to the planar surface.

The apparatus according to any one of the previous implementations further comprising a plurality of surfaces defining the recess within the body, the surfaces comprising a first surface extending radially inward from the first sidewall, a second surface disposed opposite the first surface and extending radially inward from the first sidewall, and a third surface extending between the first surface and the second surface.

In another implementation a plant pot system includes a first plant pot, comprising a first wall comprising a mount extending radially outward of the first wall, a second wall, and a base member having an outlet disposed therein, the base member extending between the first wall and the second wall. A second plant pot comprises a first wall comprising a mount extending radially outward of the first wall, a second wall, a base member extending between the first wall and the second wall, and a cap having an inlet formed therein, the cap coupled to the first wall. A coupling element extends from the first wall mount of the first plant pot to the first wall mount of the second plant pot, and a conduit extends from the outlet of the base member of the first plant pot to the inlet of the cap of the second plant pot.

The apparatus according to any one of the previous implementations wherein a first hose barb adapter is coupled to the outlet of the base member.

The apparatus according to any one of the previous implementations wherein a second hose barb adapter is coupled to the inlet of the cap.

The apparatus according to any one of the previous implementations wherein the conduit is coupled to each of and extends between the first hose barb adapter and the second hose barb adapter.

The apparatus according to any one of the previous implementations wherein the coupling element has a magnitude which is adjustable at least between a first length and a second length greater than the first length.

The apparatus according to any one of the previous implementations wherein the second length has a magnitude at least 2 times greater than a magnitude of the first length.

The apparatus according to any one of the previous implementations wherein the coupling element comprises a cable, a plurality of links, a threaded rod, a linear bearing assembly, a spring assembly, a strap, a cord, a shaft, an actuator, or combinations thereof.

The apparatus according to any one of the previous implementations wherein the conduit comprises a flexible polymeric material which is adjustable at least between a first length and a second length greater than the first length.

The apparatus according to any one of the previous implementations wherein the conduit comprises coiled tubing.

The apparatus according to any one of the previous implementations wherein a distance between the first plant pot and the second plant pot is between about 3 feet and about 10 feet.

The apparatus according to any one of the previous implementations wherein the mount of the first plant pot comprises a first mount coupled adjacent to a first end of the first wall, and a second mount coupled adjacent to a second end of the first wall opposite the first end.

The apparatus according to any one of the previous implementations wherein the mount of the second plant pot comprises a first mount coupled adjacent to a first end of the first wall, and a second mount coupled adjacent to a second end of the first wall opposite the first end.

In another implementation a plant propagation apparatus comprises a first grow pot, a second grow pot, a load cell disposed between the first grow pot and the second grow pot, a first connector disposed between the first grow pot and the load cell, and a second connector disposed between the second grow pot and the load cell.

The apparatus according to any one of the previous implementations wherein each of the first and second grow pots comprise a first wall having a first end and a second end, a second wall having a first end and a second end, the second wall disposed radially inward of the first wall, a base member extending between the second end of the first wall and the second end of the second wall, a first outlet formed through the base member, a second outlet formed through the first wall, and a plug holder coupled to the first end of the second wall.

The apparatus according to any one of the previous implementations wherein each of the first and second grow pots comprise a cylindrical first wall having a first radius and a first length, a cylindrical second wall having a second radius and a second length less than the first radius and the first length, respectively, a base member extending between the cylindrical first wall and the cylindrical second wall, a cap coupled to the cylindrical first wall opposite the base member, and a plug holder coupled to the cylindrical second wall between the cap and the base member.

The apparatus according to any one of the previous implementations wherein each of the first and second grow pots comprise a first wall comprising a mount extending radially outward of the first wall, a second wall, and a base member having an outlet disposed therein, the base member extending between the first wall and the second wall.

The apparatus according to any one of the previous implementations wherein the second grow pot is suspended beneath the first grow pot.

The apparatus according to any one of the previous implementations wherein the load cell is a tension-type load cell.

The apparatus according to any one of the previous implementations wherein the tension-type load cell is a tension link type load cell, a pancake type load cell, a canister type load cell, or an S-type load cell.

The apparatus according to any one of the previous implementations wherein the tension-type load cell is a hydraulic type load cell, a pneumatic type load cell, a piezoelectric type load cell, or strain gauge type load cell.

The apparatus according to any one of the previous implementations wherein tubing extends between and is in fluid communication with the first grow pot and the second grow pot.

The apparatus according to any one of the previous implementations wherein an irrigation connector is disposed between the first grow pot and the second grow pot.

The apparatus according to any one of the previous implementations further comprising a support member coupled to each of the first grow pot and the second grow pot.

The apparatus according to any one of the previous implementations wherein the support member comprises an accordion-like or folded portion operable to lengthen a distance between the first grow pot and the second grow pot.

The apparatus according to any one of the previous implementations wherein the support member comprises a radius of curvature selected to match a radius of curvature of an outer diameter of the first and second grow pots.

The apparatus according to any one of the previous implementations wherein the first grow pot is suspended from a superstructure and the second grow pot is suspended beneath the first grow pot.

The apparatus according to any one of the previous implementations wherein the load cell is a tension-type load cell.

The apparatus according to any one of the previous implementations wherein the tension-type load cell is a tension link type load cell, a pancake type load cell, a canister type load cell, or an S-type load cell.

The apparatus according to any one of the previous implementations wherein the tension-type load cell is a hydraulic type load cell, a pneumatic type load cell, a piezoelectric type load cell, or strain gauge type load cell.

In another implementation a plant propagation apparatus includes a column, a plurality of brackets coupled to the column, a first grow pot coupled to a first bracket of the plurality of brackets, a second grow pot coupled to a second bracket of the plurality of brackets, the second bracket coupled to the column beneath the first bracket, a first connector coupled to the first grow pot, a second connector coupled to the second grow pot, and a load cell disposed between and coupled to each of the first connector and the second connector.

The apparatus according to any one of the previous implementations wherein each of the first and second grow pots comprise a first wall having a first end and a second end, a second wall having a first end and a second end, the second wall disposed radially inward of the first wall, a base member extending between the second end of the first wall and the second end of the second wall, a first outlet formed through the base member, a second outlet formed through the first wall, and a plug holder coupled to the first end of the second wall.

The apparatus according to any one of the previous implementations wherein each of the first and second grow pots comprise a cylindrical first wall having a first radius and a first length, a cylindrical second wall having a second radius and a second length less than the first radius and the first length, respectively, a base member extending between the cylindrical first wall and the cylindrical second wall, a cap coupled to the cylindrical first wall opposite the base member and a plug holder coupled to the cylindrical second wall between the cap and the base member.

The apparatus according to any one of the previous implementations wherein each of the first and second grow pots comprise a first wall comprising a mount extending radially outward of the first wall, a second wall, and a base member having an outlet disposed therein, the base member extending between the first wall and the second wall.

The apparatus according to any one of the previous implementations wherein the first grow pot is fixedly coupled to the first bracket and the second grow pot is slidably coupled to the second bracket.

The apparatus according to any one of the previous implementations wherein the load cell is a tension-type load cell.

The apparatus according to any one of the previous implementations wherein the tension-type load cell is a tension link type load cell, a pancake type load cell, a canister type load cell, or an S-type load cell.

The apparatus according to any one of the previous implementations wherein the tension-type load cell is a hydraulic type load cell, a pneumatic type load cell, a piezoelectric type load cell, or strain gauge type load cell.

The apparatus according to any one of the previous implementations wherein the first grow pot is slidably coupled to the first bracket and the second grow pot is fixably coupled to the second bracket.

The apparatus according to any one of the previous implementations wherein the load cell is a compression-type load cell.

The apparatus according to any one of the previous implementations wherein the compression-type load cell is an S-type compression load cell, a canister type compression load cell, or pancake type compression load cell.

The apparatus according to any one of the previous implementations wherein the compression-type load cell is a hydraulic type load cell, a pneumatic type load cell, a piezoelectric type load cell, or strain gauge type load cell.

The apparatus according to any one of the previous implementations wherein the column is coupled to and suspended from a superstructure.

In another implementation a plant propagation includes a superstructure configured to support a plurality of grow pots suspended from the superstructure, a first connector coupled to the superstructure, a load cell coupled to the first connector, a second connector coupled to the load cell, and a first grow pot of the plurality of grow pots coupled to the second connector, wherein one or more second grow pots of the plurality of grow pots are suspended from the first grow pot.

The apparatus according to any one of the previous implementations wherein each of the second grow pots of the plurality of grow pots is connected to one another by additional first and second connectors.

The apparatus according to any one of the previous implementations wherein additional load cells are disposed between each of the second grow pots.

The apparatus according to any one of the previous implementations wherein the load cell and the additional load cells are tension-type load cells.

In another implementation a plant propagation apparatus includes a superstructure, a plurality of first connectors coupled to the superstructure, a plurality of load cells, each load cell of the plurality coupled to a respective first connector of the plurality of first connectors, a plurality of second connectors, each second connector of the plurality coupled to a respective load cell of the plurality of load cells, and a plurality of grow pots, each grow pot of the plurality coupled to a respective second connector of the plurality of second connectors.

The apparatus according to any one of the previous implementations wherein a length of each first connector of the plurality of first connectors is different.

The apparatus according to any one of the previous implementations wherein a length of each second connector of the plurality of second connectors is similar.

The apparatus according to any one of the previous implementations wherein a length of each first connector of the plurality of first connectors is similar.

The apparatus according to any one of the previous implementations wherein a length of each second connector of the plurality of second connectors is different.

The apparatus according to any one of the previous implementations wherein each load cell comprises a tension-type load cell.

The apparatus according to any one of the previous implementations wherein the tension-type load cell is a tension link type load cell, a pancake type load cell, a canister type load cell, or an S-type load cell.

The apparatus according to any one of the previous implementations wherein the tension-type load cell is a hydraulic type load cell, a pneumatic type load cell, a piezoelectric type load cell, or strain gauge type load cell.

In summation, plant growing apparatus described herein provide a vertically oriented grow pot architecture which enables inverted plant growth while accommodating the geotropic nature of root development. The apparatus described herein enables controlled drainage for an inverted plant and eliminates conventional trellising structures for plants. Further, the apparatus enables simultaneous aerobic and aquatic root development by positioning the roots away from terminal ends of the apparatus and by providing a plurality of volumes having different root growth mediums (i.e. solid and liquid). The vertical architectures and apparatus described herein enable efficient space utilization and variable spacing to encourage vigorous plant growth.

The architectures described herein also incorporate load cells to enable weight measurement of the grow pots within the various plant growth apparatus and systems described herein. While the grow pots described herein are inverted controlled irrigation grow pots, it is contemplated that any suitable type of plant pot, including conventional plant pots, may be advantageously implemented in the systems described herein.

While the foregoing is directed to embodiments of the present disclosure, other and further embodiments of the disclosure may be devised without departing from the basic scope thereof, and the scope thereof is determined by the claims that follow.

1. A plant pot apparatus, comprising:
a first wall having a first end and a second end;
a second wall having a first end and a second end, the second wall disposed radially inward of the first wall;
a base member extending between the second end of the first wall and the second end of the second wall;
a first outlet formed through the base member;
a second outlet formed through the first wall; and
a plug holder coupled to the first end of the second wall.

2. The apparatus of claim 1, further comprising:
a cap coupled the first end of the first wall, the cap having an inlet formed therein.

3. The apparatus of claim 1, wherein the plug holder comprises:
a body having a first surface and a second surface opposing the first surface;
a first sidewall extending from the first surface;
a second sidewall extending from the second surface;
a third surface extending between the first sidewall and the second sidewall; and
a recess formed in the body, the recess extending from the first surface to the second surface.

4. The apparatus of claim 3, wherein the recess formed in the body is defined by a fourth surface and a fifth surface, wherein the fourth surface and fifth surface are oriented substantially parallel to one another, and wherein a curvilinear sixth surface extends between the fourth surface and the fifth surface.

5. The apparatus of claim 2, wherein the first wall defines a first volume which extends between the cap and the plug holder.

6. The apparatus of claim 1, wherein the first wall and the second wall define a second volume which extends between the plug holder and the base member.

7. The apparatus of claim 6, wherein the second volume is substantially annular.

8. The apparatus of claim 6, wherein the second wall further defines a third volume disposed radially inward of the second wall, the third volume extending from the plug holder to the base member.

9. The apparatus of claim 1, wherein a length of the first wall is between about 1.5 and about 3 times greater than a length of the second wall.

10. A plant pot apparatus, comprising:
a cylindrical first wall having a first radius and a first length;
a cylindrical second wall having a second radius and a second length less than the first radius and the first length, respectively;
a base member extending between the cylindrical first wall and the cylindrical second wall;
a cap coupled to the cylindrical first wall opposite the base member; and
a plug holder coupled to the cylindrical second wall between the cap and the base member.

11. The apparatus of claim 10, wherein the cylindrical first wall at least partially defines a first volume and the cylindrical second wall at least partially defines a second volume, and wherein the first volume and second volume are in fluid communication with one another.

12. The apparatus of claim 11, wherein the first volume is substantially cylindrical and the second volume is substantially annular.

13. The apparatus of claim 10, further comprising:
a third volume at least partially defined by the cylindrical second wall, wherein the third volume is in fluid communication with the first volume via a recess of the plug holder.

14. (canceled)

15. (canceled)

16. A plant propagation apparatus, comprising:
a first grow pot;
a second grow pot;
a load cell disposed between the first grow pot and the second grow pot;
a first connector disposed between the first grow pot and the load cell; and
a second connector disposed between the second grow pot and the load cell.

17. The apparatus of claim 16, wherein the second grow pot is suspended beneath the first grow pot.

18. The apparatus of claim 17, wherein the load cell is a tension-type load cell.

19. The apparatus of claim 6, wherein tubing extends between and is in fluid communication with the first grow pot and the second grow pot.

20. The apparatus of claim 16, wherein the first grow pot is suspended from a superstructure and the second grow pot is suspended beneath the first grow pot.

21. The apparatus of claim 20, wherein the load cell is a tension-type load cell.

22. A plant propagation apparatus, comprising:
a column;
a plurality of brackets coupled to the column;
a first grow pot coupled to a first bracket of the plurality of brackets;
a second grow pot coupled to a second bracket of the plurality of brackets, the second bracket coupled to the column beneath the first bracket;
a first connector coupled to the first grow pot;
a second connector coupled to the second grow pot; and
a load cell disposed between and coupled to each of the first connector and the second connector.

23. The apparatus of claim 22, wherein the first grow pot is fixedly coupled to the first bracket and the second grow pot is slidably coupled to the second bracket.

24. The apparatus of claim 23, wherein the load cell is a tension-type load cell.

25. The apparatus of claim 22, wherein the first grow pot is slidably coupled to the first bracket and the second grow pot is fixably coupled to the second bracket.

26. The apparatus of claim 25, wherein the load cell is a compression-type load cell.

27. The apparatus of claim 22, wherein the column is coupled to and suspended from a superstructure.

28. A plant propagation system, comprising:
a superstructure configured to support a plurality of grow pots suspended from the superstructure;
a first connector coupled to the superstructure;
a load cell coupled to the first connector;
a second connector coupled to the load cell; and
a first grow pot of the plurality of grow pots coupled to the second connector, wherein one or more second grow pots of the plurality of grow pots are suspended from the first grow pot.

29. The system of claim 28, wherein each of the second grow pots of the plurality of grow pots is connected to one another by additional first and second connectors.

30. The system of claim 29, wherein additional load cells are disposed between each of the second grow pots.

31. A plant support system, comprising:
a plurality of plant holders arranged along a longitudinal axis; and
at least one coupling element coupling the plurality of plant holders, wherein the coupling element is adjustable to increase a distance between plant holders of the plurality of plant holders.

32. The system of claim 31, wherein the coupling element comprises a cable, a wire, a cord, or a rope.

33. The system of claim 31, wherein extension of the coupling element increases a distance between plant holders of the plurality of plant holders.

34. The system of claim 31, wherein the coupling element comprises an elastic portion that extends as weight borne by the coupling element increases.

35. The system of claim 31, wherein each plant holder is a plant pot.

36. The system of claim 31, wherein the longitudinal axis is vertical or substantially vertical.

37. The system of claim 31, wherein the plurality of plant holders are suspended from an overhead structure.
